(19) United States
(12) Patent Application Publication
(10) Pub. No.: US 2013/0187966 A1
(43) Pub. Date: Jul. 25, 2013

(54) Liquid Ejecting Apparatus and Liquid Ejecting Method

(71) Applicant: SEIKO EPSON CORPORATION, Tokyo (JP)

(72) Inventor: Akira ABE, Matsumoto-shi (JP)

(73) Assignee: SEIKO EPSON CORPORATION, Tokyo (JP)

(21) Appl. No.: 13/741,137

(22) Filed: Jan. 14, 2013

(30) Foreign Application Priority Data
Jan. 23, 2012 (JP) 2012-010662

(51) Int. Cl. B41J 2/07

(52) U.S. Cl. CPC B41J 2/07
USPC 347/11

(57) ABSTRACT

A liquid ejecting apparatus which includes an origin drive signal generation unit which generates the origin drive signal; a signal modulation unit which modulates the origin drive signal, and sets as an origin modulation signal; a signal amplification unit which amplifies the origin modulation signal, and sets as a modulation signal; a signal conversion unit which converts the modulation signal to fire drive signal; and a liquid ejecting unit which ejects liquid according to the fire drive signal, in which a frequency of the origin modulation signal, or the fire modulation signal is set to a predetermined value when the origin drive signal is a first value or more, and a second value or less, and when the origin drive signal is other than that, the frequency is set to a value which is less than the predetermined value.

### BACKGROUND

1. Technical Field

The present invention relates to a liquid ejecting apparatus, and a liquid ejecting method.

2. Related Art

An ink jet printer has been widely used in which an image, or a document is recorded by ejecting ink onto a printing medium from a plurality of nozzles which are provided at a printing head. In such an ink jet printer, a predetermined amount of ink is ejected from a nozzle at a predetermined timing when an actuator which is provided corresponding to each nozzle of the printing head is driven according to a fire drive signal which is supplied from a driving circuit.

The driving circuit which drives the printing head modulates, for example, a drive waveform signal as a reference of a fire drive signal using a self oscillating-type pulse density modulation (PDM, for short) method, and generates the fire drive signal by performing a power amplification with respect to the modulated signal (for example, refer to JP-A-2010-114711).

In the self oscillating-type pulse density modulation method, an oscillating frequency (pulse duty ratio) fluctuates according to a signal level. Specifically, when a level of an input signal is relatively small, or relatively large, the oscillating frequency is relatively low, and becomes higher when the level of the input signal is near to a middle value. There is a problem in that, when the oscillating frequency in the pulse modulation becomes excessively high, power loss in a transistor in the last output stage is increased, and efficiency is decreased (power consumption is increased). In addition, there is a case in which the fire drive signal is lost on the way since it is not possible to follow the frequency depending on a delay performance of the circuit, and in that case, there is a problem in that ink ejecting stability is decreased since wave reproducibility is decreased.

In addition, such a problem is not a problem which occurs only in an ink jet printer, and a common problem when liquid is ejected according to a fire drive signal which is generated using the self oscillating-type pulse density modulation method.

### SUMMARY

An advantage of some aspects of the invention to prevent liquid ejecting stability from decreasing, and to suppress an increase in consumption of power when liquid is ejected according to a fire drive signal which is generated using a self oscillating-type pulse density modulation method.

The invention can be realized in the following forms or application examples.

### Application Example 1

A liquid ejecting apparatus which includes an origin drive signal generation unit which generates an origin drive signal; a signal modulation unit which generates an origin modulation signal by modulating the origin drive signal using a self oscillating-type pulse density modulation method; a signal amplification unit which generates a fire modulation signal by amplifying the origin modulation signal; a signal conversion unit which converts the fire modulation signal to a fire drive signal; and a liquid ejection unit which ejects liquid according to the fire drive signal, in which oscillating frequency in the signal modulation unit is a predetermined value when the origin drive signal is a first value or more, and a second value or less, is lower than the predetermined value when the origin drive signal is lower than the first value, and is also lower than the predetermined value when the origin drive signal is higher than the second value.

In the liquid ejecting apparatus, modulating of the origin drive signal is performed by the signal modulation unit using a self oscillating-type pulse density modulation method, and fire drive signal is generated when an output signal from the signal modulation unit is amplified. At this time, an oscillating property of the signal modulation unit is that when the origin drive signal is the first value or more, and the second value or less, the oscillating frequency is the predetermined value, is lower than the predetermined value when the origin drive signal is lower than the first value, and is also lower than the predetermined value when the origin drive signal is higher than the second value. That is, a range in which the oscillating frequency of the signal modulation unit is limited to the same value regardless of a level of the origin drive signal is present. For this reason, in the liquid ejecting apparatus, it is possible to prevent the oscillating frequency of the signal modulation unit from becoming excessively high, to suppress a decrease in liquid ejecting stability, and to suppress an increase in consumption of power.

### Application Example 2

In the liquid ejecting apparatus according to Application Example 1, the oscillating property of the signal modulation unit is that the oscillating frequency is increased along with an increase in a current value, or a voltage value of the origin drive signal in a range in which the origin drive signal is lower than the first value, is constant regardless of the increase in the current value, or the voltage value of the origin drive signal in a range in which the origin drive signal is the first value or more, and the second value or less, and is decreased along with the increase in the current value, or the voltage value of the origin drive signal in a range in which the origin drive signal is higher than the second value.

In the liquid ejecting apparatus, the oscillating property of the signal modulation unit is that the oscillating frequency is increased along with an increase in a current value, or a voltage value of the origin drive signal in a range in which the origin drive signal is lower than the first value, is constant regardless of the increase in the current value, or the voltage value of the origin drive signal in a range in which the origin drive signal is the first value or more, and the second value or less, and is decreased along with the increase in the current value, or the voltage value of the origin drive signal in a range in which the origin drive signal is higher than the second value. That is, the oscillating frequency of the signal modulation unit is limited to the same value in a range in which the current value, or the voltage value of the origin drive signal is the first value or more, and the second value or less. For this reason, in the liquid ejecting apparatus, it is possible to prevent the oscillating frequency of the signal modulation unit from becoming excessively high, to suppress the decrease in liquid ejecting stability, and to suppress the increase in consumption of power.

### Application Example 3

In the liquid ejecting apparatus according to Application Example 1, in which the signal modulation unit receives the fire modulation signal as a feedback signal, and corrects the generated origin modulation signal.

In the liquid ejecting apparatus, it is possible to execute a modulation of a self oscillating-type pulse density modulation method using the signal modulation unit.

### Application Example 4

In the liquid ejecting apparatus according to any one of Application Examples 1 to 3, in which the signal modulation unit performs a modulation after adding, or subtracting a clock signal for limiting a frequency which is generated from a predetermined reference clock signal with respect to the origin drive signal.

In the liquid ejecting apparatus, since the clock signal for limiting frequency is added, or subtracted with respect to the origin drive signal in the signal modulation unit, a maximum frequency of oscillation of the signal modulation unit is limited to a frequency of the clock signal for limiting frequency, accordingly, it is possible to prevent the oscillating frequency of the signal modulation unit from becoming excessively high. Accordingly, in the liquid ejecting apparatus, it is possible to suppress the decrease in liquid ejecting stability, and to suppress the increase in consumption of power. In addition, in the liquid ejecting apparatus, since the maximum oscillating frequency is determined without being affected by a delay time in the signal modulation unit, or unevenness of external components, it is possible to secure a predetermined response performance using a minimum necessary consumption of power.

### Application Example 5

The liquid ejecting apparatus according to Application Examples 4 further includes an input terminal which inputs the plurality of reference clock signals of which frequencies are different from each other; a selection unit for selecting one of the plurality of input reference clock signals; an attenuator which attenuates the selected reference clock signal with an attenuation factor which is selected according to the selected reference clock signal; a differentiator which generates the clock signal for limiting frequency by differentiating the reference clock signal which is attenuated with a differential constant which is selected according to the selected reference clock signal, and supplies the clock signal for limiting frequency to the signal modulation unit.

In the liquid ejecting apparatus, since the clock signal for limiting frequency is generated based on the reference clock signal which is selected using the selection unit, the frequency of the generated clock signal for limiting frequency is fluctuated according to a result which is selected in the selection unit. For this reason, it is possible to suitably set the maximum oscillating frequency of the signal modulation unit due to the selection in the selection unit. In addition, in the liquid ejecting apparatus, since the attenuation factor in the attenuator, or the differential constant in the differentiator is selected according to the reference clock signal which is selected in the selection unit, it is possible to perform the attenuation by the attenuator according to a result which is selected in the selection unit using a suitable attenuation factor, to perform the differentiation by the differentiator using a suitable differential constant, and to set the maximum oscillating frequency of the signal modulation unit with high precision.

### Application Example 6

The liquid ejecting apparatus according to Application Examples 4 further includes an input terminal which inputs the plurality of reference clock signals of which frequencies are different from each other; a plurality of attenuators which are provided corresponding to each of the plurality of reference clock signals, and attenuate the corresponding reference clock signals with an attenuation factor which is preset according to the corresponding reference clock signal; a plurality of differentiators which are provided corresponding to each of the plurality of reference clock signals, and generate the clock signal for limiting frequency by differentiating the corresponding reference clock signal after attenuating, with a differential constant which is preset according to the corresponding reference clock signal; and a selection unit for selecting one of the plurality of clock signals for limiting frequency which is generated by the plurality of differentiators, and supplying the clock signal to the signal modulation unit.

In the liquid ejecting apparatus, since one of the clock signal for limiting frequencies which is selected in the selection unit in the plurality of clock signal for limiting frequencies which are generated by the attenuator and the differentiator based on the plurality of reference clock signals of which frequencies are different from each other is supplied to the signal modulation unit, the frequency of the clock signal for limiting frequency which is supplied to the signal modulation unit is fluctuated according to a result of selection in the selection unit. For this reason, it is possible to suitably set a maximum oscillating frequency of the signal modulation unit using a selection in the selection unit. In addition, in the liquid ejecting apparatus, since the attenuation factor in the attenuator, or the differential constant in the differentiator is preset according to a frequency of the corresponding reference clock signal, it is possible to perform the attenuation by the attenuator using a suitable attenuation factor, to perform the differentiation by the differentiator using a suitable differential constant, and to set the maximum oscillating frequency of the signal modulation unit with high precision.

### Application Example 7

The liquid ejecting apparatus according to Application Example 5, or 6 further includes an ejection mode selection unit which selects one liquid ejection mode among options of a plurality of liquid ejection modes of which the fire drive signals to be used are different from each other, and in which the selection unit performs the selection according to the selected liquid ejection mode.

In the liquid ejecting apparatus, it is possible to suitably set the maximum oscillating frequency of the signal modulation unit according to the fire drive signal which is used in an adopted liquid ejection mode, and to optimize consumption of power, and response speed.

### Application Example 8

In the liquid ejecting apparatus according to any one of Application Examples 1 to 7, the origin drive signal is a signal which is formed by a trapezoidal waveform.

In the liquid ejecting apparatus, even when a signal which is formed by the trapezoidal waveform in which a period in which a signal level becomes intermediate is largely present compared to a signal which is formed by a rectangular waveform is used as the origin drive signal, it is possible to prevent the oscillating frequency of the signal modulation unit from becoming excessively high, to suppress the decrease in liquid ejecting stability, and to suppress the increase in consumption of power.

In addition, the present invention can be realized in various modes, for example, a liquid ejecting method, a driving circuit for driving a liquid ejecting head, and a driving method, a liquid ejecting apparatus having such a liquid ejecting head and a driving circuit, and a control method thereof, a printing apparatus which has such a liquid ejecting head and driving circuit, and performs printing by ejecting ink as liquid, and a printing method thereof, and can be realized in forms of a computer program for executing these methods, or functions of devices, a recording medium which records the computer program, and the like.

### BRIEF DESCRIPTION OF THE DRAWINGS

The invention will be described with reference to the accompanying drawings, wherein like numbers reference like elements.

FIG. 1 is an explanatory diagram which illustrates a schematic configuration of a printing system according to a first example of the present invention.

FIG. 2 is an explanatory diagram which illustrates a schematic configuration centered on a control unit of a printer.

FIG. 3 is an explanatory diagram which illustrates an example of various signals which are supplied to a printing head.

FIG. 4 is an explanatory diagram which illustrates a configuration of a switching controller of the printing head.

FIG. 5 is an explanatory diagram which illustrates a schematic configuration of a driving circuit which drives the printing head.

FIG. 6 is an explanatory diagram which illustrates a functional block of a modulation circuit.

FIG. 7 is an explanatory diagram which illustrates an example of a specific functional configuration of the driving circuit.

FIG. 8 is an explanatory diagram which illustrates an oscillating frequency in the modulation circuit.

FIGS. 9A to 9D are explanatory diagrams which illustrate examples of the oscillating frequency of the modulation circuit.

FIG. 10 is an explanatory diagram which illustrates a schematic configuration of a driving circuit according to a second example.

FIG. 11 is an explanatory diagram which illustrates a schematic configuration of a driving circuit according to a third example.

### DESCRIPTION OF EXEMPLARY EMBODIMENTS

Subsequently, embodiments of the present invention will be described based on examples.

### A. First Example

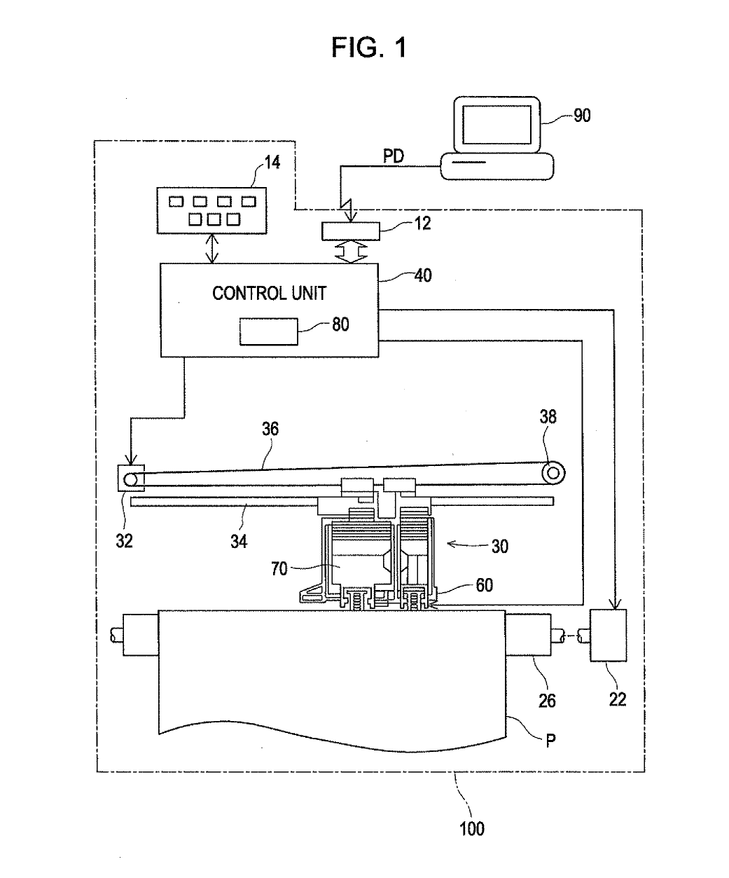

FIG. 1 is an explanatory diagram which illustrates a schematic configuration of a printing system according to a first example of the present invention. A printing system in the example includes a printer 100, and a host computer 90 which supplies printing data PD to the printer 100. The printer 100 is connected to the host computer 90 through a connector 12.

The printer 100 according to the example is an ink jet printer as a type of a liquid ejecting apparatus which ejects liquid. The printer 100 forms ink dots on a printing medium by ejecting ink as liquid, and records characters, figures, images, or the like according to the printing data PD, in this manner.

As illustrated in FIG. 1, the printer 100 includes a carriage 30 which mounts a printing head 60, a movement mechanism which performs main scanning in which the carriage 30 is reciprocated along the direction which is parallel to an axis of a platen 26, a transport mechanism which performs sub-scanning in which a sheet P as a printing medium is transported to a direction which intersects the main scanning direction (sub-scanning direction), an operation panel 14 which performs various operations of instruction and setting relating to printing, and a control unit 40 which controls each unit of the printer 100. In addition, the carriage 30 is connected to the control unit 40 through a flexible cable (FFC) which is not shown.

The transport mechanism which transports the sheet P has a paper feed motor 22. A rotation of the paper feed motor 22 is transported to a sheet transport roller (not shown) through a gear train (not shown), and the sheet P is transported along the sub-scanning direction due to the rotation of the sheet transport roller.

The movement mechanism which causes the carriage 30 to reciprocate includes a carriage motor 32, a sliding axis 34 which is stretched in parallel to an axis of the platen 26, and holds the carriage 30 to be slid, and a pulley 38 at which an endless driving belt 36 is extended between the carriage motor 32 and the pulley.

A rotation of the carriage motor 32 is transmitted to the carriage 30 through the driving belt 36, and due to this, the carriage 30 reciprocates along the sliding axis 34. In addition, in order to detect a position of the carriage 30 (printing head 60) along the main scanning direction, the printer 100 includes an encoder (not shown) which outputs a pulsatile signal to the control unit 40 along with the rotation of the carriage motor 32. The control unit 40 generates a timing signal PTS which defines an input timing of a driving signal selection signal SI & SP to a shift register 63 to be described later based on the pulsatile signal which is output from the encoder. The control unit 40 includes a driving circuit 80. A configuration of the driving circuit 80 will be described later.

The carriage 30 is mounted with a plurality of ink cartridges 70 in which ink of each predetermined color (for example, cyan (C), light cyan (Lc), magenta (M), light magenta (Lm), yellow (Y), black (K)) is accommodated. The ink which is accommodated in the ink cartridge 70 which is mounted to the carriage 30 is supplied to the printing head 60. In addition, the printing head 60 includes a plurality of nozzles which eject ink, and actuators (nozzle actuator) which are provided corresponding to each nozzle. According to the example, a piezoelectric element as a nozzle actuator which is a capacitive load is used. When the nozzle actuator is driven by a fire drive signal to be described later, a vibrating plate in a cavity (pressure chamber) which communicates with the nozzle is displaced, and causes a change in pressure in the cavity, whereby ink is ejected from a corresponding nozzle due to the change in pressure. It is possible to adjust an ejecting amount (that is, size of dots to be formed) of ink by adjusting a peak value of the fire drive signal which is used when driving the nozzle actuator, or inclination of increase and decrease in a voltage.

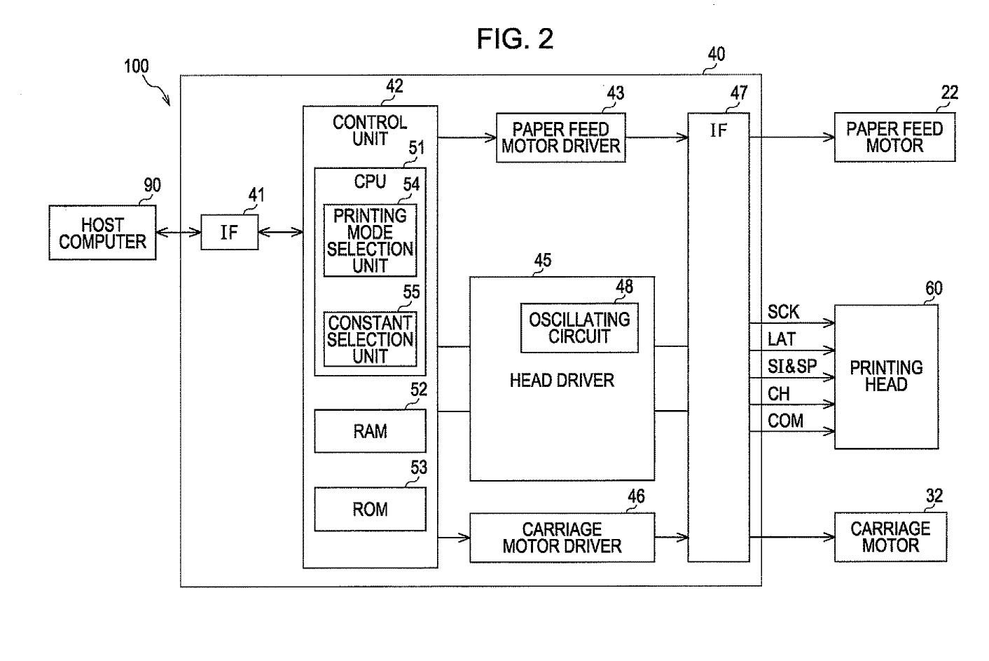

FIG. 2 is an explanatory diagram which illustrates a schematic configuration in which the control unit 40 of the printer 100 is main. The control unit 40 includes an interface 41 which inputs print data PD or the like which is input from the host computer 90, a control section 42 which performs a predetermined arithmetic processing based on the printing data PD which is input through the interface 41, a paper feed motor driver 43 which controls driving of the paper feed motor 22, a head driver 45 which controls driving of the printing head 60, a carriage motor driver 46 which controls driving of the carriage motor 32, and an interface 47 which connects each driver 43, 45, and 46 to the paper feed motor 22, printing head 60, and the carriage motor 32, respectively. The head driver 45 includes an oscillating circuit 48 which outputs a reference clock signal.

The control section 42 includes a CPU 51 which executes various arithmetic processes, a RAM 52 which temporarily stores and develops a program, or data, and a ROM 53 which stores a program or the like which is executed by the CPU 51. The various functions of the control section 42 can be executed when the CPU 51 is operated based on the program which is stored in the ROM 53. In addition, at least a part of the functions of the control section 42 may be executed when an electric circuit included in the control section 42 is operated based on a circuit configuration thereof.

For example, the CPU 51 of the control section 42 functions as a printing mode selection unit 54, and a constant selection unit 55. The printer 100 according to the example performs printing using one printing mode which is selected according to a type of a printing medium to be used in printing, or a desired printing image quality, a printing speed, and the like from among options of a plurality of printing modes. The options of the plurality of printing modes includes a plurality of options in which fire drive signals COM (to be described later) to be used are different from each other (for example, frequency or shape of fire drive signal COM are different from each other). The printing mode selection unit 54 selects a printing mode to be adopted from among the plurality of options of the printing mode based on an instruction from the host computer 90, or based on the printing data PD which is supplied from the host computer 90. The printing mode selection unit 54 outputs a printing mode selection signal PS which denotes a selected printing mode to each unit of the printer 100 (for example, drive waveform signal generation circuit 81 to be described later).

The constant selection unit 55 selects a number of divisions of a variable frequency divider 86, an attenuation factor of an attenuator 88, and differential constant of a differentiator 89 (both will be described later). According to the example, the constant selection unit 55 selects a suitable number of divisions of the variable frequency divider 86 according to a printing mode which is selected by the printing mode selection unit 54.

In addition, the constant selection unit 55 selects a suitable attenuation factor of the attenuator 88, and the differential constant of the differentiator 89 according to the number of divisions of the selected variable frequency divider 86. The constant selection unit 55 outputs a selected signal SEL which denotes selected each constant with respect to the variable frequency divider 86, the attenuator 88, and the differentiator 89.

When obtaining the printing data PD from the host computer 90 through the interface 41, the control section 42 executes a predetermined process with respect to the printing data PD, generates nozzle selection data (fire drive signal selection data) which defines from which nozzle of the printing head 60 the ink will be ejected, or how much ink will be ejected, and outputs a control signal to each driver 43, 45, and 46 based on the printing data PD, the fire drive signal selection data or the like. Each driver 43, 45, and 46 outputs the fire drive signal which drives the paper feed motor 22, the printing head 60, and the carriage motor 32, respectively. For example, the head driver 45 supplies the reference clock signal SCK, a latch signal LAT, the driving signal selection signal SI & SP, a channel signal CH, and the fire drive signal COM to the printing head 60. When the paper feed motor 22, the printing head 60, the carriage motor 32 are operated according to the fire drive signal, the printing process to the sheet P is executed.

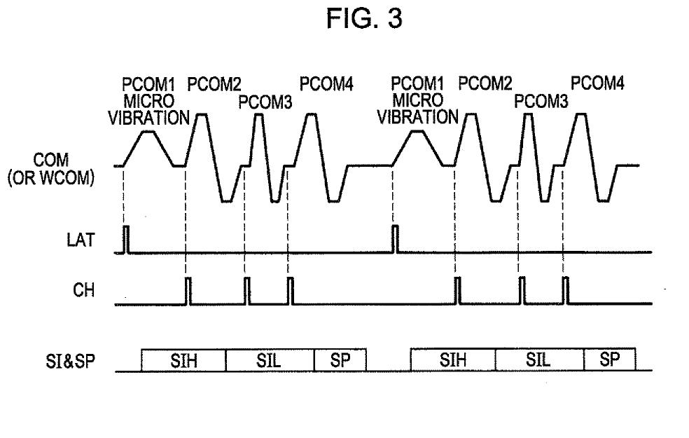

FIG. 3 is an explanatory diagram which illustrates an example of various signals which are supplied to the printing head 60. The fire drive signal COM is a signal which drives the nozzle actuator which is provided in the printing head 60. The fire drive signal COM is a signal in which driving pulses PCOM (driving pulses PCOM 1 to PCOM 4) as a minimum unit of the fire drive signal which drives the nozzle actuator is continuous in time sequence. A set of four driving pulses PCOM of driving pulses PCOM 1 to PCOM 4 corresponds to one pixel (printing pixel). In addition, as described later, the fire drive signal COM is generated from the driving waveform signal WCOM as a reference thereof, and the driving waveform signal WCOM is a signal which has the same waveform as the fire drive signal COM.

Each driving pulse PCOM is configured by a trapezoidal wave voltage. A rising portion of each driving pulse PCOM is a portion for drawing in ink (it can also be said as drawing meniscus in, when considering ejecting of ink) by enlarging a capacity of a cavity which communicates with a nozzle, and a rising portion of the driving pulse PCOM is a portion for pushing the ink out (it can also be said as pushing meniscus out, when considering ejecting of ink) by contracting the capacity of the cavity. For this reason, when the nozzle actuator is driven according to the driving pulse PCOM, ink is ejected from a nozzle.

In the fire drive signal COM, waveforms of the driving pulses PCOM 2 to PCOM 4 (inclination of increase or decrease in voltage, or peak wave) are different from each other. When the waveform of the driving pulse PCOM which is supplied to the nozzle actuator is different, an amount, or a speed of drawing ink in, and an amount, or a speed of pushing ink out become different, and due to this, an ejecting amount of ink becomes different (that is, size of ink dots). It is possible to form ink dots of many sizes by selecting one, or a plurality of driving pulses PCOM from among the driving pulses PCOM 2 to PCOM 4, and supplying the selected driving pulse PCOM to the nozzle actuator. In addition, according to the example, the driving pulse PCOM 1 which is referred to as micro vibration is included in the fire drive signal COM. The driving pulse PCOM 1 is used when ink is only drawn in, not being pushed out, for example, when suppressing thickening in the nozzle.

In this manner, the fire drive signal COM according to the example is a series of signals which are repeated in which a predetermined intermediate level is maintained for a certain period of time excluding a portion of the micro vibration driving pulse PCOM 1, and is gradually increased toward a predetermined high level from the intermediate level, the high level is maintained for a certain period of time, and is gradually reduced toward a predetermined low level from the high level, the low level is maintained for a certain period of time, and is gradually increased toward the intermediate level from the low level. In addition, in the present specification, when a signal maintains a certain level, it means that the signal is not practically (significantly) fluctuated from a certain level though minute fluctuation due to a noise, or an error is allowed. In addition, a level of the signal is a current value, or a voltage value.

The driving signal selection signal SI & SP is a signal which selects a nozzle which ejects ink based on the printing data PD, and determines a connection timing to the fire drive signal COM of the nozzle actuator. The latch signal LAT, and the channel signal CH are signals in which the fire drive signal COM and the nozzle actuator of the printing head 60 are caused to be connected to each other based on the driving signal selection signal SI & SP, after nozzle selection data of whole nozzle is input. As illustrated in FIG. 3, the latch signal LAT, and the channel signal CH are signals which are synchronized with the fire drive signal COM. That is, the latch signal LAT is a signal which becomes a high level corresponding to a start timing of the fire drive signal COM, and the channel signal CH is a signal which becomes a high level corresponding to a start timing of each driving pulse PCOM which configures the fire drive signal COM. Outputs of a series of fire drive signals COM are started according to the latch signal LAT, and each driving pulse PCOM is output according to the channel signal CH. In addition, the reference clock signal SCK is a signal for transmitting the driving signal selection signal SI & SP to the printing head 60 as a serial signal. That is, the reference clock signal SCK is a signal which is used when determining a timing of ejecting ink from the nozzle of the printing head 60.

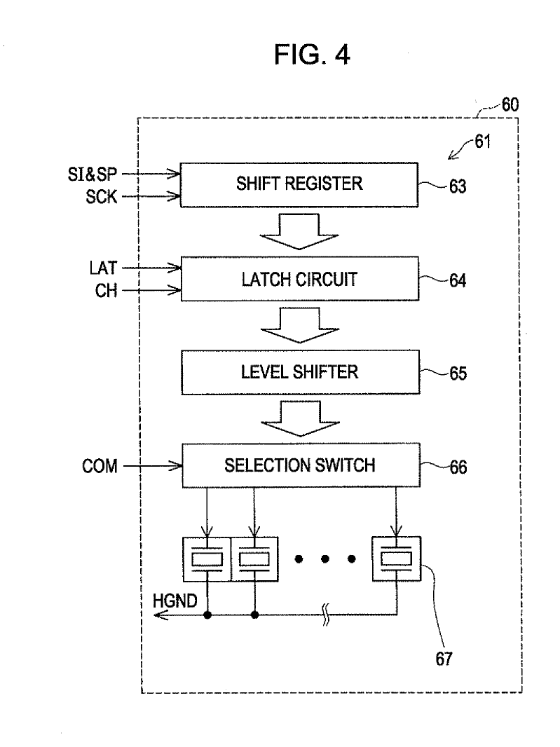

FIG. 4 is an explanatory diagram which illustrates a configuration of a switching controller 61 of the printing head 60. The switching controller 61 is built in the printing head 60 in order to supply the fire drive signal COM (driving pulse PCOM) to the nozzle actuator 67. The switching controller 61 includes a shift register 63 which stores the driving signal selection signal SI & SP, a latch circuit 64 which temporarily stores data of the shift register 63, a level shifter 65 which supplies an output of the latch circuit 64 to a selection switch 66 by performing a level conversion, and the selection switch 66 which connects the fire drive signal COM to the nozzle actuator 67.

The driving signal selection signal SI & SP is sequentially input to the shift register 63, and a region to be stored is sequentially shifted to a rear stage according to an input pulse of the reference clock signal SCK. In addition, the input of the driving signal selection signal SI & SP to the shift register 63 is executed according to the above described timing signal PTS. The latch circuit 64 latches each output signal of the shift register 63 according to the input latch signal LAT after the driving signal selection signals SI & SP by the number of nozzles are input to the shift register 63. The signal which is stored in the latch circuit 64 is converted to a voltage level in which the selection switch 66 can be switched (ON/OFF) in the next stage using the level shifter 65. The nozzle actuator 67 corresponding to the selection switch 66 which is closed due to an output signal of the level shifter 65 (becomes connected state) is connected to the fire drive signal COM (driving pulse PCOM) at a connection timing of the driving signal selection signal SI & SP. In addition, the next driving signal selection signal SI & SP is input to the shift register 63 after the driving signal selection signal SI & SP which is input to the shift register 63 is latched to the latch circuit 64, and stored data of the latch circuit 64 is sequentially updated according to an ink ejection timing. According to the selection switch 66, even after the nozzle actuator 67 is separated from the fire drive signal COM (driving pulse PCOM), an input voltage of the nozzle actuator 67 is maintained to a voltage which is immediately previous to the separation. In addition, the reference numeral HGND in FIG. 4 is a ground end of the nozzle actuator 67.

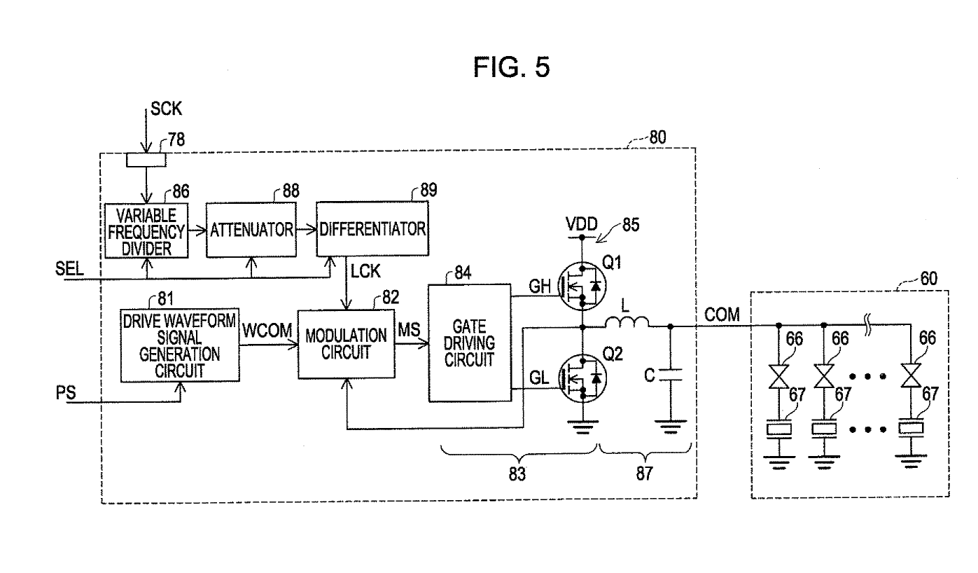

FIG. 5 is an explanatory diagram which illustrates a schematic configuration of a driving circuit 80 for driving the printing head 60. The driving circuit 80 is a circuit which generates the above described fire drive signal COM, and supplies the signal to the nozzle actuator 67 of the printing head 60, and is built in the control section 42 in the control unit 40, and in a head driver 45 (refer to FIG. 2). The driving circuit 80 includes a drive waveform signal generation circuit 81, a modulation circuit 82, a digital power amplification circuit (so-called class D amplifier) 83, a smoothing filter 87, the variable frequency divider 86, the attenuator 88, the differentiator 89, and an input terminal 78.

The drive waveform signal generation circuit 81 generates a drive waveform signal WCOM as a reference of the fire drive signal COM which drives the nozzle actuator 67 based on drive waveform data DWCOM which is stored in advance. The drive waveform signal generation circuit 81 corresponds to an origin drive signal generation unit according to the embodiment of the present invention, and the drive waveform signal WCOM corresponds to the origin drive signal according to the embodiment of the present invention. As described above, the printing mode selection signal PS which is output from the printing mode selection unit 54 is input to the drive waveform signal generation circuit 81. The drive waveform signal generation circuit 81 outputs the drive waveform signal WCOM according to a printing mode which is specified by the printing mode selection signal PS.

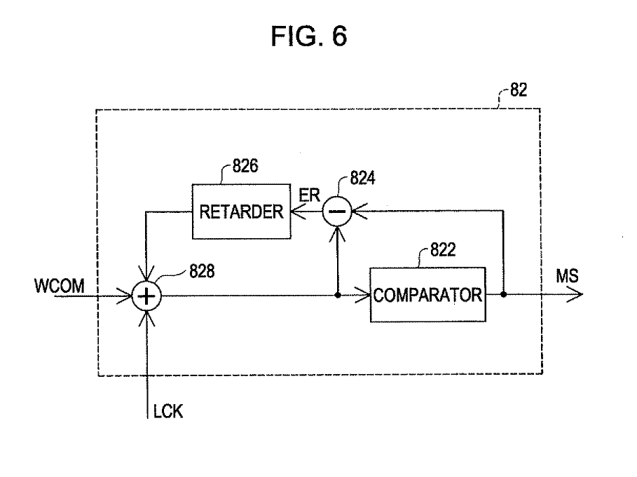

The modulation circuit 82 performs a pulse modulation with respect to the drive waveform signal WCOM which is generated in the drive waveform signal generation circuit 81, and outputs a modulation signal MS. The modulation circuit 82 corresponds to the signal modulation unit according to the embodiment of the present invention, and the modulation signal MS corresponds to the origin modulation signal according to the embodiment of the present invention. FIG. 6 is an explanatory diagram which illustrates a function block of the modulation circuit 82. The modulation circuit 82 is a so-called ΔΣ modulation circuit according to the example which performs a pulse modulation using a self oscillating-type pulse density modulation (PDM) method. The modulation circuit 82 includes a comparator 822 which outputs the modulation signal MS which becomes a high level when an input signal is a predetermined value or more when comparing the input signal to the predetermined value, a subtracter 824 which calculates an error ER between the input signal and an output signal of the comparator 822, a retarder 826 which retards the error ER, and an adder-subtracter 828 which adds or subtracts the retarded error ER to or from the drive waveform signal WCOM as the original signal. In addition, the modulation signal MS which is output from the modulation circuit 82 is a signal which denotes a waveform using a density of a pulse. In addition, it is also possible to omit the retarder 826 using an output of an external retarder, like a modulator in an example to be described later.

A modulation method in the modulation circuit 82 according to the example is the pulse density modulation method of self oscillation type, and an oscillating frequency fluctuates according to a signal level (pulse duty ratio) of the input drive waveform signal WCOM. Specifically, the oscillating frequency in the pulse density modulation method is the highest when a level of the input signal is an intermediate value, and is gradually decreased when the level of the input signal becomes large, or small from the intermediate value. The pulse duty ratio in the vicinity of the intermediate value is approximately 50%, however, the pulse duty ratio is changed along with the decrease in the oscillating frequency. The method is advantageous in that it is possible to obtain a wide variation width of the pulse duty ratio compared to a pulse width modulation method of a fixed modulation frequency, and to secure an output dynamic range which is wide. That is, since a minimum positive pulse width, and a minimum negative pulse width which can be treated in the entire modulation circuit are limited in circuit characteristics thereof, a pulse signal less than that is lost in the mean time. For this reason, in the pulse width modulation method of fixed modulation frequency, only a variation width of a pulse duty ratio in a predetermined range (for example, 10% to 90%) can be secured. In contrast to this, in the self oscillating-type pulse density modulation method according to the example, since the oscillating frequency is decreased when a level of the input signal becomes large, or small from the intermediate value, since it is possible to treat a signal of which the pulse duty ratio is larger at a portion at which the level of the input signal is extremely large, and to treat a signal of which the pulse duty ratio is smaller at a portion at which the level of the input signal is extremely small, the variation width of the pulse duty ratio of a wider range (for example, 5% to 95%) can be secured. Hereinafter, a specific example will be described. For example, when the minimum positive and negative pulse widths which can be treated in the entire circuit are both 25 ns, only the pulse duty ratio variation width of 10% to 90% can be secured, since the pulse duty ratio variation width is determined at a ratio to a cycle thereof in a case in which the modulation frequency is fixed to 4 MHz. On the other hand, in the self oscillating-type pulse density modulation method according to the example, when the oscillating frequency is changed according to the level of the input signal, and is set to 2 MHz, for example, in both cases where the level of the input signal is low, and where the level of the input signal is high, it is possible to secure the pulse duty ratio variation width of 5% to 95%. In this manner, it is possible to secure a wide output dynamic range. In addition, in the self oscillating-type pulse density modulation method according to the example, since it is not necessary to provide an external circuit which generates a high frequency signal, like a non-self oscillating modulation method of fixed frequency, it is advantageous when configurating a system, for example, in which configuring the system in one chip is relatively easy.

The digital power amplification circuit 83 (FIG. 5) amplifies power of the modulation signal MS which is output from the modulation circuit 82, and outputs a power amplification modulation signal. The digital power amplification circuit 83 corresponds to the signal amplification unit according to the embodiment of the present invention, and the power amplification modulation signal corresponds to the fire modulation signal according to the embodiment of the present invention.

The digital power amplification circuit 83 includes a half-bridge output stage 85 which is formed by two switching elements (switching element Q1 on high side, and switching element Q2 on low side) for substantially amplifying power, and a gate driving circuit 84 which adjusts signals between gate and source GH and GL of the switching elements Q1 and Q2 based on the modulation signal MS from the modulation circuit 82. In the digital power amplification circuit 83, when the modulation signal MS is a high level, the switching element Q1 on the high side becomes an ON state, since the signal between gate and source GM becomes a high level, and the switching element Q2 on the low side becomes an OFF state, since the signal between gate and source GL becomes a low level. As a result, an output of the half-bridge output stage 85 becomes a supply voltage VDD. On the other hand, when the modulation signal MS is a low level, the switching element Q1 on the high side becomes the OFF state, since the signal between gate and source GM becomes a low level, and the switching element Q2 on the low side becomes the ON state, since the signal between gate and source GL becomes a high level. As a result, an output of the half-bridge output stage 85 becomes zero. In this manner, the power amplification is performed in the digital power amplification circuit 83 by switching operation of the switching element Q1 on the high side, and the switching element Q2 on the low side based on the modulation signal MS.

The smoothing filter 87 smoothens a power amplification modulation signal which is output from the digital power amplification circuit 83, generates the fire drive signal COM (driving pulse PCOM), and supplies the fire drive signal COM to the nozzle actuator 67 through the selection switch 66 of the printing head 60 (refer to FIG. 4). The smoothing filter 87 corresponds to the signal modulation unit according to the embodiment of the present invention. In the example, a low pass filter in which a combination of a capacitor C and a coil L is used as the smoothing filter 87 is used. The smoothing filter 87 attenuates and removes a modulation frequency component which is generated in the modulation circuit 82, and outputs the fire drive signal COM (driving pulse PCOM) having a waveform property which is described above. As described above, since the drive waveform signal generation circuit 81 outputs the drive waveform signal WCOM according to a printing mode which is specified by the printing mode selection signal PS, the fire drive signal COM also becomes a signal corresponding to a printing mode which is generated based on the drive waveform signal WCOM.

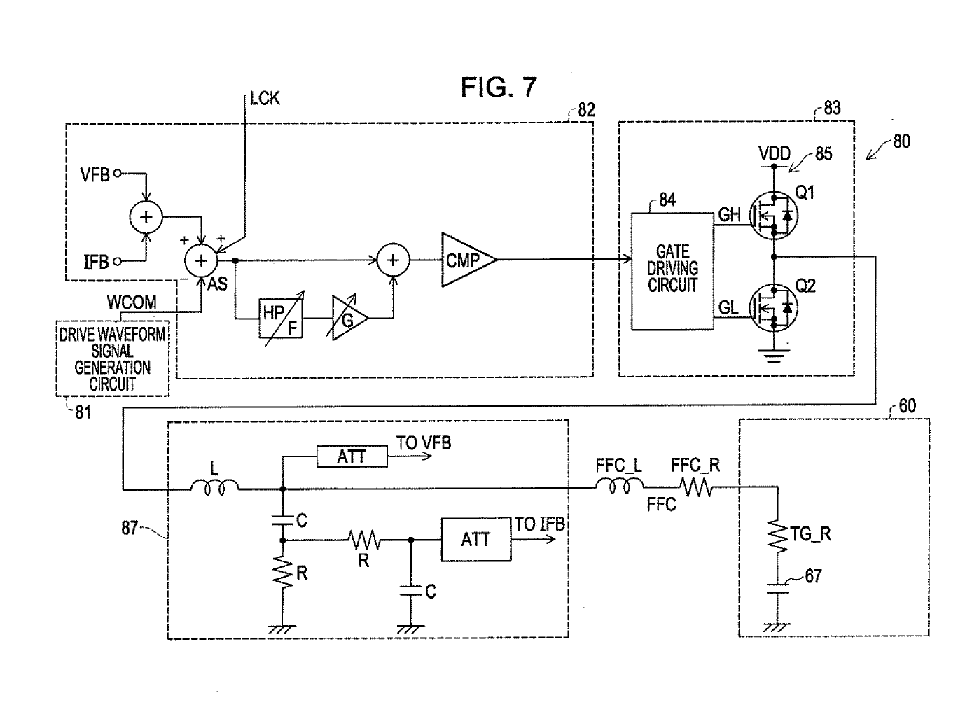

FIG. 7 is an explanatory diagram which illustrates an example of a specific functional configuration of the driving circuit 80. As described above, the modulation circuit 82 according to the example is a modulation circuit of the pulse density modulation method. In addition, the driving circuit 80 according to the example is different from the ΔΣ modulation circuit in FIG. 6, and use a modulator not having a retarder. Since the low pass filter is another expression of the retarder, an output of an LC low pass filter (COM) is used as a retarding signal instead of the retarder. In addition, according to the example, a circuit which emphasizes high frequency components (high pass filter (HP-F) and high frequency boost (G)), and a circuit which returns the high frequency components (denoted by “IFB”) are added thereto. That is, in the example, the modulation circuit 82 receives the modulation signal MS after being amplified by the digital power amplification circuit 83 as a returning signal, and corrects the generated modulation signal MS.

The reference clock signal SCK which is output from the oscillating circuit 48 (FIG. 2) is input to an input terminal 78 (FIG. 5) of the driving circuit 80. The variable frequency divider 86 divides the reference clock signal SCK which is input through the input terminal 78 using the variable number of divisions. As described above, the selection signal SEL which is output from the constant selection unit 55 is input to the variable frequency divider 86. The variable frequency divider 86 divides the reference clock signal SCK using the number of divisions which are specified by the selection signal SEL. Accordingly, a frequency of the reference clock signal SCK after being divided fluctuate according to the number of divisions in the variable frequency divider 86.

The attenuator 88 attenuates the reference clock signal SCK after being divided which is output from the variable frequency divider 86 using a variable attenuation factor. As described above, the selection signal SEL which is output from the constant selection unit 55 is input to the attenuator 88. The attenuator 88 attenuates the reference clock signal SOK after being divided using an attenuation factor which is specified by the selection signal SEL.

The differentiator (high pass filter) 89 generates a clock signal for limiting frequency LCK by differentiating the reference clock signal SOK after being attenuated which is output from the attenuator 88 using a variable differential constant. As described above, the selection signal SEL which is output from the constant selection unit 55 is input to the differentiator 89. The differentiator 89 differentiates the reference clock signal SCK after being attenuated using a differential constant which is specified by the selection signal SEL, and generates the clock signal for limiting frequency LCK. The differentiator 89 outputs the generated clock signal for limiting frequency LCK to the modulation circuit 82.

In this manner, since the clock signal for limiting frequency LCK is generated based on the reference clock signal SCK which is divided in the variable frequency divider 86, a frequency of the generated clock signal for limiting frequency LCK fluctuates according to the number of divisions in the variable frequency divider 86.

In the modulation circuit 82, the clock signal for limiting frequency LCK is input to the adder-subtracter (AS) 828 (FIGS. 6 and 7). The clock signal for limiting frequency LCK is added to, or subtracted from the drive waveform signal WCOM using the adder-subtracter (AS) 828.

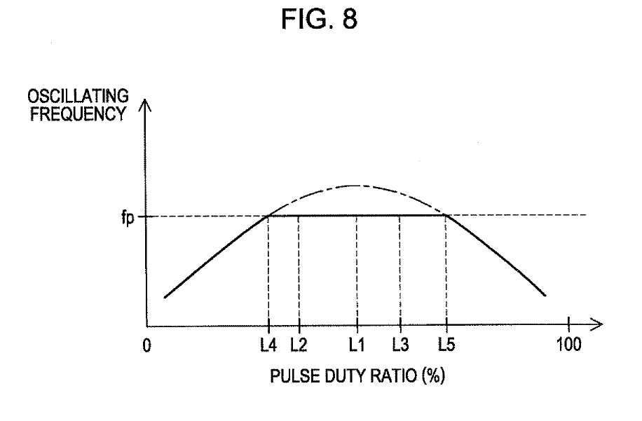

In this manner, according to the example, since the clock signal for limiting frequency LCK is input to the modulation circuit 82, and the input clock signal for limiting frequency LCK is added to, or subtracted from the drive waveform signal WCOM using the adder-subtracter (AS) 828, an oscillating frequency in the modulation circuit 82 is limited to a frequency of the clock signal for limiting frequency LCK. FIG. 8 is an explanatory diagram which illustrates an oscillating frequency in the modulation circuit 82. When there is no input of the clock signal for limiting frequency LCK, as described above, the oscillating frequency of the modulation circuit 82 becomes the highest in a case where the level of the input signal (pulse duty ratio) is an intermediate value, and becomes low in a case where the level of the input signal becomes large, or small from the intermediate value (refer to one dotted dashed line in FIG. 8). However, in the modulation circuit 82 according to the example in which the clock signal for limiting frequency LCK is added to, or subtracted from the drive waveform signal WCOM using the adder-subtracter (AS) 828, when the oscillating frequency is close to the clock signal for limiting frequency LCK, the oscillating frequency is drawn into the clock signal for limiting frequency LCK, and is fixed to the frequency fp of the clock signal for limiting frequency LCK (refer to solid line in FIG. 8). When a level of the input signal is varied, and the original oscillating frequency is greatly out of the frequency fp of the clock signal for limiting frequency LCK, the fixation to the clock signal for limiting frequency LCK is released, and the oscillating frequency of the modulation circuit 82 returns to a common oscillating frequency corresponding to a level of the input signal. In this manner, the oscillating property of the modulation circuit 82 according to the example has the first level L1, the second level L2, and the third level L3 in which the oscillating frequency is the same, when the level of the drive waveform signal WCOM is the first level L1, the second level L2 which is smaller than the first level L1, and the third level L3 which is larger than the first level L1, respectively. More specifically, the oscillating property of the modulation circuit 82 according to the example can be expressed as a property in which, when the drive waveform signal WCOM is the fourth level L4 or more, and the fifth level L5 or less, the oscillating frequency is a predetermined value fp, when the drive waveform signal WCOM is lower than the fourth level L4, the oscillating frequency is lower than the predetermined value fp, and when the drive waveform signal WCOM is higher than the fifth level L5, the oscillating frequency is also lower than the predetermined value fp. Alternatively, in the oscillating property, the oscillating frequency is increased along with an increase in level of the drive waveform signal WCOM when the drive waveform signal WCOM is in a rage of the fourth level L4 or less, the oscillating frequency is the predetermined value fp regardless of the increase in level of the drive waveform signal WCOM when the drive waveform signal WCOM is in a range of the fourth level L4 or more, and the fifth level L5 or less, which is larger than the fourth level L4, and the oscillating frequency is decreased along with the increase in level of the drive waveform signal WCOM, when the drive waveform signal WCOM is in a range of the fifth level L5 or more.

As described above, since the frequency fp of the clock signal for limiting frequency LCK fluctuates according to the number of divisions in the variable frequency divider 86, it is possible to change the maximum oscillating frequency in the modulation circuit 82 by changing the number of divisions in the variable frequency divider 86.

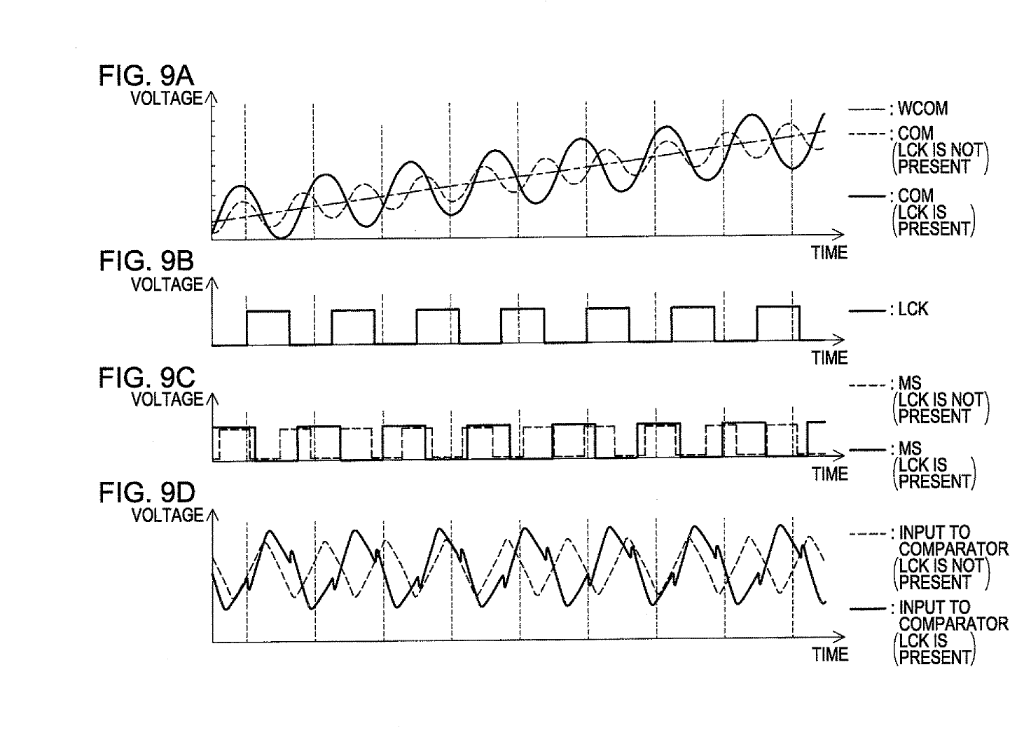

FIGS. 9A to 9D are explanatory diagrams which illustrates an example of the oscillating frequency in the modulation circuit 82. FIG. 9B illustrates an example of the clock signal for limiting frequency LCK which is input to the modulation circuit 82. In addition, FIG. 9D illustrates an example of an input signal to the comparator (CMP) 822. In FIG. 9D, the signal which is denoted by a dashed line is a signal of a comparison example in which the clock signal for limiting frequency LCK is not input to the modulation circuit 82. A frequency of the signal of the comparison example is higher than the frequency of the clock signal for limiting frequency LCK which is denoted in FIG. 9B. On the other hand, the signal which is denoted by a solid line in FIG. 9D is a signal when the clock signal for limiting frequency LCK is input to the modulation circuit 82 as in the example. The frequency of the signal is lower than the frequency in the comparison example, and specifically, is the same as the frequency of the clock signal for limiting frequency LCK which is denoted in FIG. 9B.

Similarly, FIG. 9C illustrates an example of the modulation signal MS as an output signal from the comparator (CMP) 822. In FIG. 9C, the signal which is denoted by a dashed line is a signal of a comparison example in which the clock signal for limiting frequency LCK is not input to the modulation circuit 82, and is a signal with a higher frequency than the frequency of the clock signal for limiting frequency LCK which is illustrated in FIG. 9B. On the other hand, the signal which is denoted by a solid line in FIG. 9B is a signal when the clock signal for limiting frequency LCK is input to the modulation circuit 82 as in the example, a frequency thereof is lower than that of the signal in the comparison example, and specifically, is a signal in which the frequency is the same as that of the clock signal for limiting frequency LCK which is illustrated in FIG. 9B.

In addition, FIG. 9A illustrates an example of the fire drive signal COM which is generated based on the modulation signal MS. The signal which is denoted by the dashed line in FIG. 9A is a signal in a comparison example in which the clock signal for limiting frequency LCK is not input to the modulation circuit 82, and a signal with a higher frequency than that of the clock signal for limiting frequency LCK which is illustrated in FIG. 9B. On the other hand, the signal which is denoted by a solid line in FIG. 9A is a signal when the clock signal for limiting frequency LCK is input to the modulation circuit 82 as in the example, is a signal with the lower frequency than that of the signal in the comparison example, and specifically, is a signal with the same frequency as that of the clock signal for limiting frequency LCK which is illustrated in FIG. 9B. In addition, the drive waveform signal WCOM is denoted by one dotted dashed line in FIG. 9A, for reference.

In addition, in FIGS. 9A and 9D, the reason why an amplitude of the signal in the comparison example in which the clock signal for limiting frequency LCK is input to the modulation circuit 82 is larger than that of the signal in the comparison example in which the clock signal for limiting frequency LCK is not input, is that the lower the frequency, the larger the error to be returned.

As described above, in the printer 100 according to the example, a modulation of the drive waveform signal WCOM to the modulation signal MS is performed using the self-oscillating PDM method by the modulation circuit 82, the modulation signal MS is amplified in power by the digital power amplification circuit 83, and the fire drive signal COM is generated. At this time, in the oscillating property of the modulation circuit 82, the oscillating frequency becomes the predetermined value fp when the drive waveform signal WCOM is the fourth level L4 or more, and the fifth level L5 or less, becomes lower than the predetermined value fp when the drive waveform signal WCOM is lower than the fourth level L4, and also becomes lower than the predetermined value fp when the drive waveform signal WCOM is higher than the fifth level L5. That is, the maximum oscillating frequency of the modulation circuit 82 is limited to the frequency of the clock signal for limiting frequency LCK. For this reason, in the printer 100 according to the example, it is possible to prevent the oscillating frequency of the modulation circuit 82 from becoming excessively high, to suppress loss of stability when ejecting ink, and to suppress the increase in consumption of power.

More specifically, the oscillating property of the modulation circuit 82 according to the example is that the oscillating frequency is increased along with the increase in level of the drive waveform signal WCOM when the drive waveform signal WCOM is in a range of the fourth level L4 or less, is constant regardless of the increase in level of the drive waveform signal WCOM, when the drive waveform signal WCOM is in a range which is the fourth level L4 or more, and is the fifth level L5 or less which is larger than the fourth level L4, and is decreased along with the increase in level of the drive waveform signal WCOM, when the drive waveform signal WCOM is in a range of the fifth level L5 or more. For this reason, in the printer 100 according to the example, it is possible to prevent the oscillating frequency when the signal level in the modulation circuit 82 is approximately intermediate from becoming excessively high, to suppress loss of stability when ejecting ink, and to suppress the increase in consumption of power.

In addition, in the printer 100 according to the example, since the modulation circuit 82 performs the modulation after adding or subtracting the clock signal for limiting frequency LCK which is generated from the reference clock signal SCK with respect to the drive waveform signal WCOM, the oscillating property of the modulation circuit 82 becomes the above described property, and it is possible to prevent the oscillating frequency of the modulation circuit 82 from becoming excessively high. In addition, in the printer 100 according to the example, since the maximum oscillating frequency is determined without being affected by a delay time in the modulation circuit 82, or unevenness of external components, it is possible to secure a predetermined response performance using a minimum necessary consumption of power.

In addition, in the printer 100 according to the example, the reference clock signal SCK is input to the variable frequency divider 86, is divided using the variable number of divisions, the divided reference clock signal SCK is attenuated by the attenuator 88, the attenuated reference clock signal SCK is differentiated by the differentiator 89, is set to the clock signal for limiting frequency LCK, and adding or subtracting of the clock signal for limiting frequency LCK with respect to the drive waveform signal WCOM is performed by the adder-subtracter (AS) 828 of the modulation circuit 82. At this time, it is possible to change the frequency of the clock signal for limiting frequency LCK which is generated from the reference clock signal SCK, and to suitably set the maximum oscillating frequency of the modulation circuit 82 by changing the number of divisions of the variable frequency divider 86.

In addition, in the printer 100 according to the example, since the clock signal for limiting frequency LCK is generated using the reference clock signal SCK as a signal which is used when determining an ejecting timing of ink from a nozzle, it is not necessary to prepare a dedicated clock signal in order to limit the maximum oscillating frequency of the modulation circuit 82, and it is possible to prevent the apparatus from becoming complicated and large.

In addition, in the printer 100 according to the example, the constant selection unit 55 selects the attenuation factor of the attenuator 88, and the differential constant of the differentiator 89 according to the number of divisions of selected the variable frequency divider 86. For example, the constant selection unit 55 selects a relatively small attenuation factor when the selected number of division is relatively small (that is, frequency of reference clock signal SCK after being divided is relatively large), and a relatively small differential constant. For this reason, in the printer 100 according to the example, it is possible to perform the attenuation by the attenuator 88 using a suitable attenuation factor, to perform the differentiating by the differentiator 89 using a suitable differential constant, according to the frequency of the reference clock signal SCK after being divided, and it is possible to set the maximum oscillating frequency of the modulation circuit 82 with high precision.

In addition, in the printer 100 according to the example, the printing mode selection unit 54 selects one printing mode from among the plurality of options of printing mode including the plurality of options in which the fire drive signals CCM to be used are different from each other, and the constant selection unit 55 selects the number of divisions of the variable frequency divider 86 according to the selected printing mode. For this reason, in the printer 100 according to the example, it is possible to suitably set the maximum oscillating frequency of the modulation circuit 82 according to the fire drive signal COM which is used in an adopted printing mode, and to optimize the consumption of power and the response speed.

In addition, since the fire drive signal COM, or the drive waveform signal WCOM which are used in the example are configured by trapezoidal waveforms, there are a lot of periods in which signal levels are approximately intermediate compared to signals which are configured by the rectangular waveform. In the printer 100 according to the example, it is possible to prevent the oscillating frequency of the modulation circuit 82 from becoming excessively high, to suppress loss of stability when ejecting ink, and to suppress the increase in consumption of power, even when using the fire drive signal which is configured by such a trapezoidal waveform for driving the printing head 60.

### B. Second Example

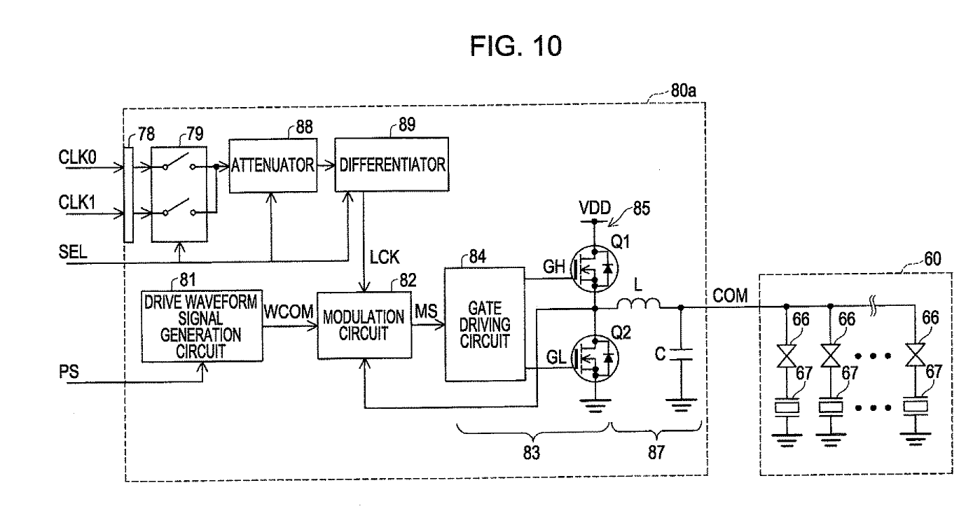

FIG. 10 is an explanatory diagram which illustrates a schematic configuration of a driving circuit 80a in the second example. The driving circuit 80a according to the second example has a configuration for generating a clock signal for limiting frequency LCK which is different from that of the driving circuit 80 in the first example which is described in FIG. 5, and others than that are the same as those in the first example. The driving circuit 80a according to the second example includes an input terminal 78, a selection unit 79, an attenuator 88, and a differentiator 89 as a configuration for generating the clock signal for limiting frequency LCK.

Two reference clock signals CLK 0 and CLK 1 which are output from the oscillating circuit 48 (FIG. 2) of which frequencies are different from each other are input to the input terminal 78. It is possible to arbitrarily set the frequencies of the two reference clock signals CLK 0 and CLK 1. One of the two reference clock signals may be the same as the reference clock signal SCK which is described in the first example. In addition, the two reference clock signals may be signals which are different from the reference clock signal SCK which is described in the first example.

The selection unit 79 selects one of the two reference clock signals CLK 0 and CLK 1 which are input through the input terminal 78. The selection by the selection unit 79 is performed according to the selection signal SEL from the constant selection unit 55 (FIG. 2).

The attenuator 88 attenuates the reference clock signal SCK (CLK 0, or CLK 1) which is selected by the selection unit 79 using an attenuation factor which is specified by the selection signal SEL. The differentiator 89 differentiates the reference clock signal after being attenuated which is output from the attenuator 88 using a differential constant which is specified by the selection signal SEL, and generates the clock signal for limiting frequency LCK. The differentiator 89 outputs the generated clock signal for limiting frequency LCK to the modulation circuit 82. Similarly to first example, the clock signal for limiting frequency LCK which is input to the modulation circuit 82 is added to, or subtracted from the drive waveform signal WCOM by the adder-subtracter (AS) 828 (FIG. 6).

In addition, the constant selection unit 55 selects the reference clock signal according to a printing mode which is selected by the printing mode selection unit 54 (FIG. 2), selects an attenuation factor of the attenuator 88, or a differential constant of the differentiator 89 according to the selected reference clock signal (frequency thereof), and outputs the selected reference clock signal, the attenuation factor, the selection signal SEL which denotes the differential constant toward the selection unit 79, the attenuator 88, and the differentiator 89.

In this manner, according to the second example, since the clock signal for limiting frequency LCK is input to the modulation circuit 82 similarly to the first example, the oscillating frequency in the modulation circuit 82 is limited by the frequency of the clock signal for limiting frequency LCK. That is, even in the second example, in the oscillating property of the modulation circuit 82, when the drive waveform signal WCOM is in a range of the fourth level L4 or more, and the fifth level L5 or less, the oscillating frequency becomes the predetermined value fp, when the drive waveform signal WCOM is lower than the fourth level L4, the oscillating frequency becomes lower than the predetermined value fp, and when the drive waveform signal WCOM is higher than the fifth level L5, the oscillating frequency becomes lower than the predetermined value fp, as well. More specifically, in the oscillating property of the modulation circuit 82, when the drive waveform signal WCOM is in a range of the fourth level L4 or less, the oscillating frequency is increased along with the increase in level of the drive waveform signal WCOM, when the drive waveform signal WCOM is in a range of the fourth level L4 or more, and the fifth level L5 or less which is larger than the fourth level L4, the oscillating frequency is constant regardless of the increase in level of the drive waveform signal WCOM, and when the drive waveform signal WCOM is in a range of the fifth level L5 or more, the oscillating frequency is decreased along with the increase in level of the drive waveform signal WCOM. For this reason, in the printer 100 according to the second example, it is possible to prevent the oscillating frequency of which the signal level is approximately intermediate from becoming excessively high in the modulation circuit 82, to suppress loss of stability when ejecting ink, and to suppress the increase in consumption of power.

In addition, in the printer 100 according to the second example, since the clock signal for limiting frequency LCK is generated on the basis of the reference clock signal which is selected in the selection unit 79, the frequency of the generated clock signal for limiting frequency LCK fluctuates according to a selection result in the selection unit 79. For this reason, it is possible to suitably select the maximum oscillating frequency of the modulation circuit 82 using the selection in the selection unit 79.

In addition, in the printer 100 according to the second example, the attenuation factor in the attenuator 88, or the differential constant in the differentiator 89 is selected according to the reference clock signal which is selected in the selection unit 79. That is, the constant selection unit 55 (FIG. 2) designates the suitable attenuation factor and differential constant corresponding to the frequency of the reference clock signal using the selection signal SEL, when one reference clock signal is selected in the selection unit 79. For this reason, in the printer 100 according to the second example, it is possible to perform the attenuation by the attenuator 88 using a suitable attenuation factor, to perform the differentiation by the differentiator 89 using a suitable differential factor, and to set the maximum oscillating frequency of the modulation circuit 82 with high precision according to the selection result in the selection unit 79.

In addition, in the printer 100 according to the second example, the printing mode selection unit 54 selects one printing mode from among the plurality of options of printing mode including the plurality of options in which the fire drive signals OCM to be used are different from each other, and the constant selection unit 55 selects the reference clock signal, the attenuation factor, and the differential constant according to the selected printing mode. For this reason, in the printer 100 according to the second example, it is possible to suitably set the maximum oscillating frequency of the modulation circuit 82 according to the fire drive signal COM which is used in the adopted printing mode, and to optimize the consumption of power and the response speed.

### C. Third Example

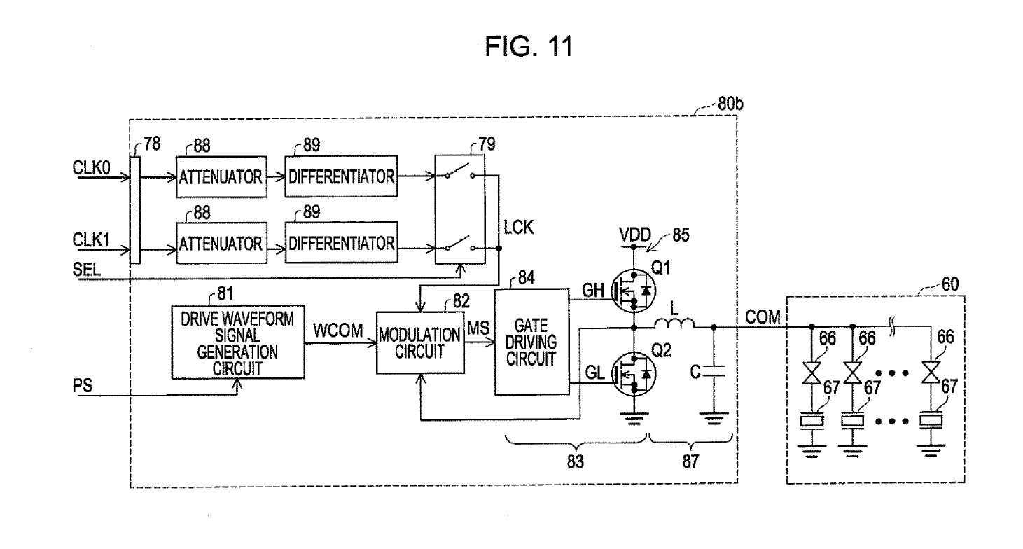

FIG. 11 is an explanatory diagram which illustrates a schematic configuration of a driving circuit 80b according to a third example. In the driving circuit 80b according to the third example, a configuration for generating a clock signal for limiting frequency LCK is different from that in the driving circuit 80 according to first example in FIG. 5, and others than that are the same as those in the first example. The driving circuit 80b according to the third example includes one input terminal 78, two attenuators 88, two differentiators 89, and one selection unit 79 as a configuration for generating the clock signal for limiting frequency LCK.

Two reference clock signals CLK 0 and CLK 1 which are output from the oscillating circuit 48 (FIG. 2) of which frequencies are different from each other are input to the input terminal 78. It is possible to arbitrarily set the frequencies of the two reference clock signals CLK 0 and CLK 1. One of the two reference clock signals may be the same as the reference clock signal SCK which is described in the first example. In addition, the two reference clock signals may be signals which are different from the reference clock signal SCK which is described in the first example.

The two attenuators 88 are provided corresponding to the two reference clock signals CLK 0 and CLK 1 which are input through the input terminal 78, respectively. That is, one reference clock signal CLK 0 is input to one attenuator 88, and the other reference clock signal CLK 1 is input to the other attenuator 88. Each attenuator 68 attenuates an input reference clock signal CLK using an attenuation factor which is preset according to a frequency of the corresponding reference clock signal CLK.

The two differentiators 89 are provided corresponding to the two reference clock signals CLK 0 and CLK 1 which are input through the input terminal 78, respectively. That is, one reference clock signal CLK 0 is input to one differentiator 89 through the one attenuator 88, and the other reference clock signal CLK 1 is input to the other differentiator 89 through the other attenuator 88. Each differentiator 89 differentiates a reference clock signal which is input after being attenuated by the attenuator 88 using a differential constant which is preset according to a corresponding frequency of a reference clock signal CLK, and generates a clock signal for limiting frequency LCK.

The selection unit 79 selects one clock signal for limiting frequency LCK which is generated in each differentiator 89, and supplies the signal to the modulation circuit 82. The selection by the selection unit 79 is performed according to the selection signal SEL from the constant selection unit 55 (FIG. 2). The clock signal for limiting frequency LCK which is input to the modulation circuit 82 is added to, or subtracted from the drive waveform signal WCOM using the adder-subtracter (AS) 828 (FIG. 6), similarly to that in the first example 1.

In addition, the constant selection unit 55 selects a clock signal for limiting frequency LCK to be supplied to the modulation circuit 82 according to a printing mode which is selected by the printing mode selection unit 54 (FIG. 2), and outputs a selection signal SEL which denotes the selected clock signal for limiting frequency LCK to the selection unit 79.

In this manner, similarly to the first example, since the clock signal for limiting frequency LCK is input to the modulation circuit 82 in the third example, the oscillating frequency in the modulation circuit 82 is limited to the frequency of the clock signal for limiting frequency LCK. That is, in the third example, as well, in the oscillating frequency of the modulation circuit 82, when the drive waveform signal WCOM is in a range of the fourth level L4 or more, and the fifth level L5 or less, the oscillating frequency is the predetermined value fp, when the drive waveform signal WCOM in lower than the fourth level L4, the oscillating frequency is lower than the predetermined value fp, and when the drive waveform signal WCOM is higher than the fifth level L5, the oscillating frequency is lower than the predetermined value fp, as well. More specifically, in the oscillating property of the modulation circuit 82, when the drive waveform signal WCOM is in a range of the fourth level L4 or less, the oscillating frequency is increased along with the increase in level of the drive waveform signal WCOM, when the drive waveform signal WCOM is in a range of the fourth level L4 or more, and the fifth level L5 or less which is larger than the fourth level L4, the oscillating frequency is constant regardless of the increase in level of the drive waveform signal WCOM, and when the drive waveform signal WCOM is in a range of the fifth level L5 or more, the oscillating frequency is decreased along with the increase in level of the drive waveform signal WCOM. For this reason, in the printer 100 according to the third example, it is possible to prevent the oscillating frequency of which the signal level is approximately intermediate from becoming excessively high in the modulation circuit 82, to suppress loss of stability when ejecting ink, and to suppress the increase in consumption of power.

In addition, in the printer 100 according to the third example, since one clock signal for limiting frequency LCK which is selected in the selection unit 79 in the two clock signals for limiting frequency LCK which are generated by the attenuator 88, and the differentiator 89 based on the two reference clock signals of which the frequencies are different from each other is supplied to the modulation circuit 82, the frequency of the clock signal for limiting frequency LCK which is supplied to the modulation circuit 82 fluctuates according to a selection result in the selection unit 79. For this reason, it is possible to suitably set the maximum oscillating frequency of the modulation circuit 82 using a selection in the selection unit 79.

In addition, in the printer 100 according to the third example, an attenuation factor in the attenuator 88, or a differential constant in the differentiator 89 is set in advance according to the frequency of the corresponding reference clock signal CLK. For this reason, in the printer 100 according to the third example, it is possible to perform the attenuation by the attenuator 88 using a suitable attenuation factor, to perform the differentiation by the differentiator 89 using a suitable differential constant, and to set the maximum oscillating frequency of the modulation circuit 82 with high precision.

In addition, in the printer 100 according to the third example, the printing mode selection unit 54 selects one printing mode from a plurality of printing mode including a plurality of options in which fire drive signals COM to be used are different from each other, the constant selection unit 55 selects a clock signal for limiting frequency LCK to be supplied to the modulation circuit 82 according to a selected printing mode. For this reason, in the printer 100 according to the third example, it is possible to suitably set the maximum oscillating frequency of the modulation circuit 82 according to the fire drive signal COM which is used in the adopted printing mode, and to optimize the consumption of power and the response speed.

### D. Modification Example

In addition, the present invention is not limited to the above described examples, or embodiments, can be embodied in various modes without departing from the scope of the invention, and for example, can also be modified as follows.

### D1. Modification Example 1

The printer 100 according to the example is only an example, and it is possible to performs various modifications. For example, in the above described example, a piezoelectric element is used as the nozzle actuator 67, however, other nozzle actuators may be used.

In addition, in the above described example, the printer 100 performs printing processing by receiving the printing data PD from the host computer 90, however, instead of this, for example, the printer 100 may perform the printing processing by generating printing data PD based on image data which is obtained from a memory card, image data which is obtained from a digital camera through a predetermined interface, image data which is obtained by a scanner, or the like.

In addition, in the above described example, the printer 100 is a printer which performs printing while repeating an operation of reciprocating the printing head 60 (main scanning) with respect to a continuous sheet P which is located at a printing region in the predetermined direction (main scanning direction), and an operation which transports the sheet P in the transport direction which intersects the main scanning direction (sub-scanning), however, the present invention can also be applied to a so-called impact printer which performs printing on a cut sheet, or a so-called line printer which performs printing while transporting a sheet in a direction intersecting the sheet width direction under the nozzle columns which are arranged in line across the sheet width direction at the base of the printing head.

In addition, the present invention can also be applied to other apparatuses than the ink jet printer, if it is an apparatus which ejects liquid (including fluidal body such as liquid body in which particles of functional material are dispersed, gel, or the like). As such a liquid ejecting apparatus, there are, for example, a textile printing apparatus which prints patterns on cloth, a device which ejects a liquid body including materials such as an electrode material which is used when manufacturing a liquid crystal display, an Electro Luminescence (EL) display, a plane emission display, a color filter, or the like, a color material, or the like, in a form of dispersion, or dissolution, an apparatus which ejects a biological organic substance which is used when manufacturing a biochip, an apparatus which ejects liquid as a sample which is used as precision pipette, an apparatus which ejects a lubricant to a precision machine such as a clock, a camera, or the like, using a pin point, an apparatus which ejects transparent resin liquid such as UV curable resin for forming a micro bulls-eye lens (optical lens) which is used in an optical communication element, or the like, onto a substrate, and an apparatus which ejects etching liquid such as acid or alkali for etching a substrate or the like.

In addition, in the above described example, a part of the configuration which is executed using hardware may be substituted to software. On the contrary, a part of the configuration which is executed using software may be substituted to hardware.

In addition, when a part, or all of functions of the present invention are executed using the software, the software (computer program) can be provided in a form of being stored in a computer readable recording medium. In the invention, the “computer readable recording medium” is not limited to a portable recording medium such as a flexible disk, or a CD-ROM, and also includes an internal storage unit in a computer such as various RAMS, ROMs, or the like, or an external storage unit which is fixed to a computer such as a hard disk.

### D2. Modification Example 2

In the above described first example, the reference clock signal SCK is used in order to generate the clock signal for limiting frequency LCK, however, it is also possible to generate the clock signal for limiting frequency LCK using another clock signal instead of the reference clock signal SCK. For example, it is also possible to prepare for a dedicated clock signal, and use the signal in order to generate the clock signal for limiting frequency LCK. In this manner, it is possible to set the maximum oscillating frequency of the modulation circuit 82 as an arbitrary value by being separated from frequencies of other signals such as the reference clock signal SCK.

### D3. Modification Example 3

In the above described example, the constant selection unit 55 performs various selections according to a printing mode which is selected by the printing mode selection unit 54 (selection of number of divisions, selection of reference clock, selection of attenuation, selection of differential constant, selection of clock signal for limiting frequency, or the like), however, the selection by the constant selection unit 55 is not limited to such modes. For example, the constant selection unit 55 may perform various selections according to the printing head 60 which is used in printing, and may perform various selections according to a type of the printer 100. In this manner, it is possible to optimize the consumption of power, and the response speed according to the type of the printing head 60, or the printer 100 to be used.

### D4. Modification Example 4

In the above described first and second examples, the attenuation factor of the attenuator 88, and the differential constant of the differentiator 89 are variable, however, the attenuation factor of the attenuator 88, and the differential constant of the differentiator 89 may be fixed. However, as in the above described example, when it is set such that the constant selection unit 55 selects the attenuation factor of the attenuator 88, and the differential constant of the differentiator 89, it is preferable since it is possible to perform the attenuation by the attenuator 88 using a suitable attenuation factor according to the frequency of the reference clock signal SCK after being divided, or the frequency of the selected reference clock signal, and to perform the differentiation by the differentiator 89 using a suitable differential constant.

### D5. Modification Example 5

The oscillating property of the modulation circuit 82 according to the above described example is only an example, as long as properties which are described in the above described example (a property in which, when the drive waveform signal WCOM is in a range of the fourth level L4 or more, and the fifth level L5 or less, the oscillating frequency is the predetermined value fp, when the drive waveform signal WCOM is lower than the fourth level L4, the oscillating frequency is lower than the predetermined value fp, and when the drive waveform signal WCOM is higher than the fifth level L5, the oscillating frequency is lower than the predetermined value fp, as well, or a property in which the first level L1, the second level L2, and the third level L3 in which the oscillating frequency is the same are present, when there are three levels of the drive waveform signal WCOM of the first level L1, the second level L2 which is smaller than the first level L1, and the third level L3 which is larger than the first level L1, respectively) are included, it is possible to perform various modifications.

### D6. Modification Example 6

In the above described second example, two reference clock signals CLK of which the frequencies are different from each other are input to the input terminal 78, and one of the two reference clock signals CLK is selected in the selection unit 79, however, it is also possible to set such that three reference clock signals CLK of which the frequencies are different from one another are input to the input terminal 78, and one of the three or more reference clock signals CLK is selected in the selection unit 79.

In addition, in the above described third example, two reference clock signals CLK of which the frequencies are different from each other are input to the input terminal 78, and the attenuator 88, and the differentiator 89 are provided corresponding to the two reference clock signals CLK (that is, provides two, respectively), however, it is also possible to set such that three or more reference clock signals CLK of which the frequencies are different from one another are input to the input terminal 78, and the attenuator 88, and the differentiator 89 are provided corresponding to each of the reference clock signals CLK (that is, provides three or more, respectively). Even in this case, one signal is selected in the selection unit 79, and the signal is supplied to the modulation circuit 82 as the clock signal for limiting frequency LCK.

### D7. Modification Example 7

In the above described example, elements other than elements which are described in the aspect among constituent elements in the examples and modification examples are additional elements, and can be suitably omitted, or combined.

The entire disclosure of Japanese Patent Application No. 2012-010662, filed Jan. 23, 2012 is expressly incorporated by reference herein.

What is claimed is:

1. A liquid ejecting apparatus comprising:
an origin drive signal generation unit which generates an origin drive signal;
a signal modulation unit which generates an origin modulation signal by modulating the origin drive signal using a self oscillating-type pulse density modulation method;
a signal amplification unit which generates a fire modulation signal by amplifying the origin modulation signal;
a signal conversion unit which converts the fire modulation signal to a fire drive signal; and
a liquid ejection unit which ejects liquid according to the fire drive signal,
wherein a frequency of the origin modulation signal or the fire modulation signal is a predetermined value when the origin drive signal is a first value or more, and a second value or less; is lower than the predetermined value when the origin drive signal is lower than the first value; and is also lower than the predetermined value when the origin drive signal is higher than the second value.

2. The liquid ejecting apparatus according to claim 1,
wherein the oscillating property of the signal modulation unit is that the frequency is increased along with an increase in a current value, or a voltage value of the origin drive signal in a range in which the origin drive signal is lower than the first value; the frequency is constant regardless of the increase in the current value, or the voltage value of the origin drive signal in a range in which the origin drive signal is the first value or more, and the second value or less; and the frequency is decreased along with the increase in the current value, or the voltage value of the origin drive signal in a range in which the origin drive signal is higher than the second value.

3. The liquid ejecting apparatus according to claim 1,
wherein the signal modulation unit receives the fire modulation signal as a feedback signal, and corrects the generated origin modulation signal.

4. The liquid ejecting apparatus according to claim 1,
wherein the signal modulation unit performs a modulation after adding, or subtracting a clock signal for limiting a frequency which is generated from a predetermined reference clock signal with respect to the origin drive signal.

5. The liquid ejecting apparatus according to claim 4, further comprising:
an input terminal which inputs the plurality of reference clock signals of which frequencies are different from each other;
a selection unit which selects one of the plurality of input reference clock signals;
an attenuator which attenuates the selected reference clock signal with an attenuation factor which is selected according to the selected reference clock signal;
a differentiator which generates the clock signal for limiting frequency by differentiating the reference clock signal which is attenuated with differential constant selected according to the selected reference clock signal, and supplies the clock signal for limiting frequency to the signal modulation unit.

6. The liquid ejecting apparatus according to claim 4, further comprising:
an input terminal which inputs the plurality of reference clock signals of which frequencies are different from each other;
a plurality of attenuators which are provided corresponding to each of the plurality of reference clock signals, and attenuate the corresponding reference clock signals with an attenuation factor which is preset according to the corresponding reference clock signal;
a plurality of differentiators which are provided corresponding to each of the plurality of reference clock signals, and generate the clock signal for limiting frequency by differentiating the corresponding reference clock signal after attenuating, with a differential constant which is preset according to the corresponding reference clock signal; and
a selection unit which selects one of the plurality of clock signals for limiting frequency which is generated by the plurality of differentiators, and supplying the clock signal to the signal modulation unit.

7. The liquid ejecting apparatus according to claim 5, further comprising:
an ejection mode selection unit which selects one liquid ejection mode among options of a plurality of liquid ejection modes of which the fire drive signals to be used are different from each other,
wherein the selection unit performs the selection according to the selected liquid ejection mode.

8. The liquid ejecting apparatus according to claim 1,
wherein the origin drive signal is a signal which is formed by a trapezoidal waveform.

9. A liquid ejecting method comprising:
generating an origin drive signal;
generating an origin modulation signal by modulating the origin drive signal using a self oscillating-type pulse density modulation method;
generating a fire modulation signal by amplifying the origin modulation signal;
converting the fire modulation signal to a fire drive signal; and
ejecting liquid according to the fire drive signal,
wherein, a frequency of the origin modulation signal, or the fire modulation signal is a predetermined value when the origin drive signal is a first value or more, and a second value or less, is lower than the predetermined value when the origin drive signal is lower than the first value, and is also lower than the predetermined value when the origin drive signal is higher than the second value.
